(19) United States
(12) Patent Application Publication
(10) Pub. No.: US 2014/0074685 A1
(43) Pub. Date: Mar. 13, 2014

(54) PROPERTY RIGHTS MANAGEMENT PLATFORM

(71) Applicant: Les Entreprises J.S. Dufresne Inc., Montreal (CA)

(72) Inventor: Jean-Sébastien Dufresne, Montreal (CA)

(73) Assignee: Les Entreprises J.S. Dufresne Inc., Montreal (CA)

(21) Appl. No.: 14/025,798

(22) Filed: Sep. 12, 2013

Related U.S. Application Data
(60) Provisional application No. 61/699,918, filed on Sep. 12, 2012.

(51) Int. Cl. G06Q 40/04; G06Q 50/18

(52) U.S. Cl. CPC G06Q 40/04; G06Q 50/184
USPC 705/37

(57) ABSTRACT

The present document describes a platform configured to recommend in a push manner a selection of prospect acquirers for a product in a target market, the platform comprising: a product database containing product, an acquirer directory with past transactions information, a search engine configured to scan the acquirer directory to rank prospect acquirers using a set of ranking criteria; and an interface to display a selection of highly-ranked prospect acquirers. According to an embodiment, the platform is further configured to assess a transaction proposal made by a prospect acquirer for the product, the platform further comprising a proprietor directory with information about past contracts, and a processing engine configured to automatically evaluate the transaction proposal by comparing the transaction proposal information with the information stored in the acquirer directory and in the proprietor directory on the basis of assessment criteria, thereby providing a recommendation about the transaction proposal.

### CROSS-REFERENCE TO RELATED APPLICATIONS

This application claims priority from U.S. provisional patent application No. 61/699,918 filed on Sep. 12, 2012, the specification of which is hereby incorporated by reference.

### BACKGROUND

(a) Field

The subject matter disclosed generally relates to a platform configured to recommend in a push manner a prospect acquirer for a product for a target market; a platform configured to evaluate a proposal made by an acquirer for a product for a target market; and a centralized system for the promotion and sale of products, including rights for intellectual work.

(b) Related Prior Art

In a globalized economy, finding the right clients, acquirers for a special product, business partners or contacts is harder than on a local scale. However, seeking business opportunities on a global may be advantageous in various types of industries.

In the media industries, small or medium size producers usually call for local agents to help selling translation or subsidiary media rights. A local agent contacts foreign corresponding agents to inform them of media rights available in their respective country. The role of the foreign corresponding agent is to find a foreign rights acquirer interested in acquiring the media rights for his territory/language/format. For example, a Canadian agent, i.e. the local agent, may represent several Canadian media producers, i.e. provider producers, that are interested in selling media rights for other territories/languages/formats. The Canadian agent informs his international network of corresponding agents of the available media rights. For example, a German agent is interested in a particular book and contacts German publishers to inform them of the available book.

Usually, the local agent sends to the foreign corresponding agents a hard copy of a catalogue of available media content of which the rights are available, and all communications between the different agents and the different acquirers are made via emails, fax, or telephone. This results in a time consuming process, especially for the agents.

United States Patent Application, published under No. US 2007/0185816 on Aug. 9, 2007 in the name of Davis, illustrates a search engine for facilitating the sale, transfer and/or assignment of intellectual property. The search engine operates in a pull manner without suggestions or recommendations being provided to the user.

United States Patent Application, published under No. US 2008/0281748 on Nov. 13, 2008 in the name of Newman, illustrates a license exchange to provide market value of licenses and intellectual property (IP) being traded by means of an electronic auction. Again, this IP exchange tool is operated in a pull manner without suggestions or recommendations being provided to the user.

With respect to platforms for selling or licensing copyrights on literary or artistic work, there is a need for identification of prospect acquirers in foreign markets that are made in a push manner, and further a need of an assessment tool to evaluate the offers they propose.

It will be understood that the necessity of improving the way property rights are managed or sold on a global scale is not exclusive to the media industries. For example, an individual or company may benefit from an improve platform to sell products related to intellectual property. A company may want to sell a license for a trademark, a design or a patent in other regions of the world. An individual could want to sell a patent for his invention, or copyrights on what he wrote, drew or composed. In these cases, it is hard to know who would want to buy such a product because the prospect acquirers are outside the contacts known to the seller/proprietor, since they are in other countries and speak other languages. In such cases, the proprietor is often represented by an agent who deals with other agents around the world, which also suggests that the use of a specialized platform would be useful.

Other types of transactions encountered in business practice can suffer from the same problem. Finding a prospect acquirer in another market for a given product may be very difficult, especially for transactions requiring confidence in the prospect acquirer, for example if the transaction is related to rights, intellectual property or requires some type of contract. Unique or rare transactions, such as transactions found in the real estate industry or in the collection of fine arts (paintings, sculptures), would benefit from an interregional/international platform that could help evaluating the efficiency, cost and professionalism of foreign agents, representatives or acquirers with whom business is made.

A platform useful to identify prospect acquirers for a product is thus needed. To meet this need, the platform should preferably involve some way to evaluate what would be the most relevant or desirable prospect acquirers for a given target market. The platform should also include means for negotiating transactions, including an evaluation of offers made through the platform between the users (sellers/proprietors and prospect acquirers and their respective representatives/agents).

To achieve the efficiency that is required for this platform to be useful, it should have to be implemented on computing devices. The needed method for identifying a transaction opportunity and assessing a transaction proposal for a product may thus be implemented on a computer.

### SUMMARY

According to an embodiment, there is provided a platform configured to recommend in a push manner a selection of prospect acquirers for at least one product for a target market, the platform comprising: a product database containing relevant information on the at least one product for the target market; an acquirer directory with information about past transactions of prospect acquirers; a search engine, in communication with the product database and with the acquirer directory, configured to scan the acquirer directory in a push manner to rank prospect acquirers for the at least one product for the target market using a set of ranking criteria, each ranking criterion being used to weigh a piece of the information about past transactions of the prospect acquirers to rank prospect acquirers; and an interface, in communication with a client computer and with the search engine, configured to display in a push manner a selection of highly-ranked prospect acquirers.

According to another embodiment, the set of ranking criteria comprises at least one of: an existing transaction by the prospect acquirers for a product line to which the at least one product belongs; an existing transaction by the prospect acquirers with a proprietor of the at least one product; and an existing transaction by the prospect acquirers for another product similar to the at least one product.

According to another embodiment, the product database comprises at least one of a good, a service and an intangible asset.

According to another embodiment, the product database comprises intellectual work.

According to another embodiment, the intellectual work is at least one of a book, a piece of music, a song, a work of art, a TV show, a theater play, a movie, and a game.

According to another embodiment, the target market comprises at least one of a territory, a language and a format.

According to another embodiment, the relevant information on the at least one product comprises at least one of an image representing the at least one product and a descriptive text describing the at least one product.

According to another embodiment, the platform is further configured to evaluate a transaction proposal, for the target market, made by a proposing prospect acquirer for the at least one product belonging to a proprietor, wherein the interface is further configured to allow entry of relevant information of the transaction proposal for the at least one product, the platform further comprising: a proprietor directory with information about past transactions of the proprietor and with information about an outcome expected by the proprietor for the transaction proposal for the at least one product for the target market; and a processing engine, in communication with the interface, with the product database and with the acquirer directory, configured to automatically evaluate the transaction proposal, wherein the relevant information of the transaction proposal is compared with the information stored in the acquirer directory and in the proprietor directory on the basis of assessment criteria, thereby providing a recommendation about the transaction proposal.

According to another embodiment, the relevant information of the transaction proposal comprises an offered price for the at least one product.

According to another embodiment, there is further provided a multi-level permission module for determining which information about past transactions from the proprietor directory and from the acquirer directory a user is allowed to consult or to modify depending upon a status of the user in the multi-level permission module.

According to another embodiment, the assessment criteria comprise at least one of: a value of past transactions made by the proposing prospect acquirer; a value of past transactions of the proprietor directory and which were accepted by the proprietor; and a value of the outcome expected by the proprietor for the transaction proposal of the at least one product.

According to another embodiment, at least one of the prospect acquirers and of the proprietor comprises a representing agent.

In another aspect of the invention, there is provided a method for identifying a transaction opportunity and assessing a transaction proposal for at least one product, the method comprising: receiving an entry of a product from a proprietor of the at least one product in a product database; ranking prospect acquirers among those listed in an acquirer directory, the ranking being based on ranking criteria; selecting highly-ranked prospect acquirers; and sending a message about the at least one product to the highly-ranked prospect acquirers;

According to another embodiment, receiving an entry from a proprietor comprises receiving an entry from an agent representing the proprietor.

According to another embodiment, sending a message to the highly-ranked prospect acquirers comprises sending a message to agents representing the highly-ranked prospect acquirers.

According to another embodiment, there is further provided: receiving a transaction proposal for the at least one product by at least one of the highly-ranked prospect acquirers; determining if the transaction proposal is above an acceptable threshold; and if the transaction proposal is determined to be above the acceptable threshold, transmitting the transaction proposal to the proprietor.

According to another embodiment, there is further provided automatically sending the transaction proposal back to the at least one of the highly-ranked prospect acquirers with advice for improvement if the transaction proposal is determined to be under the acceptable threshold.

According to another embodiment, receiving a transaction proposal by at least one of the highly-ranked prospect acquirers comprises receiving a transaction proposal by an agent representing at least one of the highly-ranked prospect acquirers.

According to another embodiment, wherein transmitting the transaction proposal to the proprietor comprises transmitting the transaction proposal to an agent representing the proprietor.

In another aspect of the invention, there is provided a system for identifying a transaction opportunity and assessing a transaction proposal for at least one product, the system comprising: a server including an interface module configured to allow entry of relevant information of the at least one product by a proprietor of the at least one product, and entry of relevant information of the transaction proposal by a proposing prospect acquirer for the at least one product for a target market; an acquirer directory with information about past transactions of the proposing prospect acquirer; a proprietor directory with information about past contracts of the proprietor; and a search engine configured for at least one of scanning the acquirer directory in a push manner to rank prospect acquirers listed in the acquirer directory for the at least one product for the target market using a set of ranking criteria; and automatically evaluating a transaction proposal by the proposing prospect acquirer, wherein the relevant information of the transaction proposal is compared with the information stored in the acquirer directory and in the proprietor directory on the basis of assessment criteria, thereby providing a recommendation about the transaction proposal; and a client computer for enabling access of a user to the system by communicating with the interface module.

The following terms are defined below.

The term “proprietor” is intended to mean the owner of a product, for example a rights owner. In the latter case, the rights owner may be the author of a book, or its publisher. In some cases, a representing agent may also act as a proprietor or acquirer.

The term “product” is intended to mean a good or a service that can be sold or licensed, including rights on intellectual work, a work of art, real estate, franchising or an intangible asset such as intellectual property (patent, trademark, design, copyright).

The term “intellectual work” is intended to mean any work which requires translation and/or adaptation for distribution and sale in different countries/languages/formats. Such intellectual work includes, without limitation, a book, text, article, piece of music, song, TV show, theater play, movie, game, video game, internet game, mobile application, software, magazine, or logo among others.

The term “translation or subsidiary rights” is intended to mean any legal rights relating to the intellectual work which can be transferred, licensed or sold in any jurisdiction/country. Such translation or subsidiary rights include, without limitation, intellectual property rights such as trademarks, copyrights, trade secrets, license agreements or other contracts, among others.

The term “agent” is intended to mean a representative agent representing a media producer, a creator, an inventor and/or the rights owner or more generally a proprietor for promoting, transferring or selling the rights.

The term “acquirer” is intended to mean a prospect buyer or purchaser potentially interested in acquiring the product, including acquiring translation or subsidiary rights of an intellectual work.

The phrase “providing in a push manner” is intended to mean proactively delivering, giving without being asked to, displaying automatically, etc.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a block diagram illustrating a centralized system comprising a server, according to an embodiment.

FIGS. 2a and 2b are flow charts illustrating the reasoning/decision tree involved in accordance with an embodiment of the platform for selecting and ranking acquirers most likely interested in translation or subsidiary rights (and to be interesting for the rights owner).

FIG. 3 is a flowchart illustrating the steps performed for evaluating a proposal made by a prospect acquirer according to an embodiment.

FIGS. 4a to 4p are screen shots illustrating an interface in accordance with an embodiment of the platform.

FIG. 5 is a diagram illustrating a multi-level software architecture in which an embodiment of the invention may be practiced.

FIG. 6 is a diagram illustrating a hardware environment in which an embodiment of the invention may be implemented.

It will be noted that throughout the appended drawings, like features are identified by like reference numerals.

### DETAILED DESCRIPTION

There is provided a platform for managing property rights, particularly well adapted for media rights (such as copyrights on a book, song, music, movie, etc.) and other intellectual property rights (trademarks, patents, designs) in that the platform yields many advantageous for licensing a right in various target markets with high confidence and low risk for both the proprietor and the prospect acquirers. The platform may also be useful for facilitating the sale of a product in various markets by facilitating the identification of prospect acquirers and by evaluating business proposals made through the platform. The platform is also well suited for business transaction requiring an agent (real estate agent, patent agent, art dealers, etc.) representing a proprietor or a prospect acquirer, since agents have the time and the budget to subscribe to a specialized platform, since it is a part of their work to know and use this kind of tool.

In an embodiment, the platform allows negotiation and communication between the users of the platform. The platform has the possibility to be many times more time-efficient than the current practice of finding interesting offers through paper catalogues of rights available for licensing. The platform is also more efficient than sending emails to tens or hundreds of prospect acquirers without knowing which ones are more probable to respond in a positive way. This gain in efficiency requires computing devices on which the platform is implemented.

The platform may comprise a user interface to allow users (proprietor, prospect acquirer, or more probably, the agents who represent them) to use the platform conveniently. The interface allows entering data on a product, on a proprietor, or on a prospect acquirer, searching through electronic catalogues manually or using keywords on a search engine 112. The interface is also adapted to enable messaging between the users, transmitting business proposals regarding a given product in a given target market, or allow the visualization of relevant statistics by users.

### Use of the Platform and System Implementation

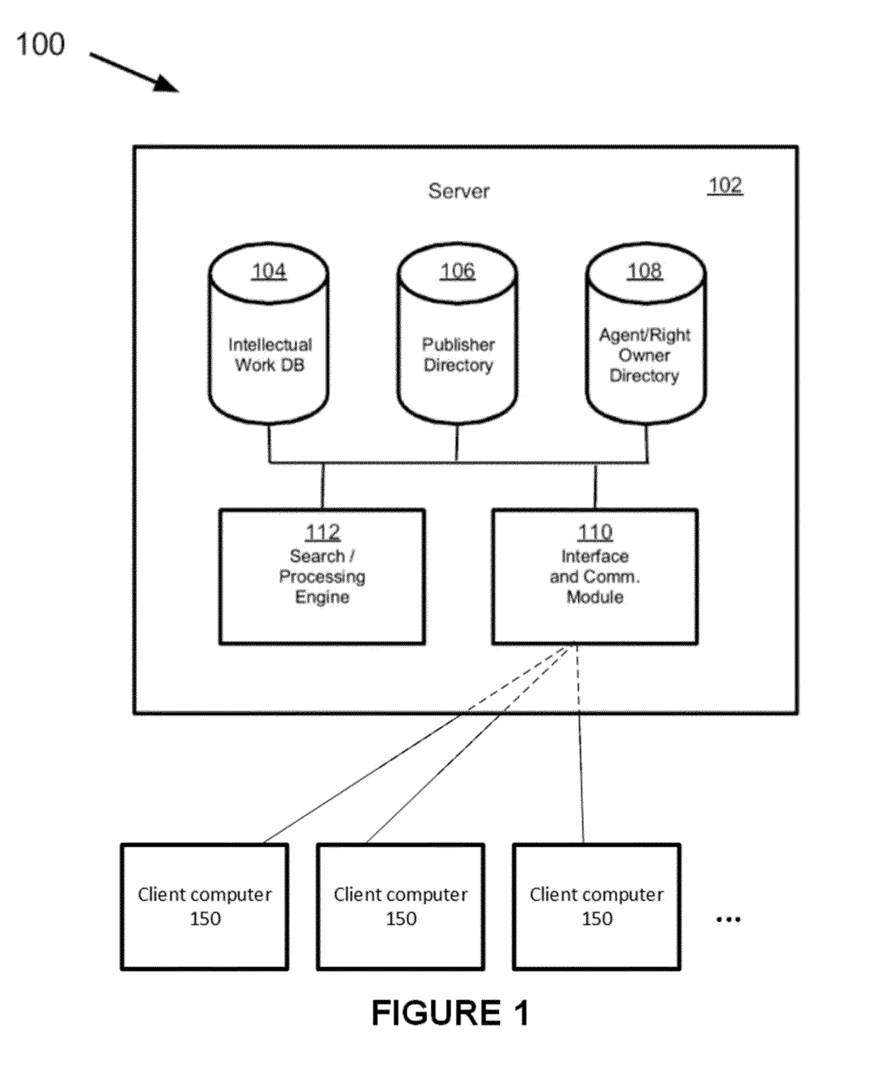

The platform may be implemented on a server 102. Referring to FIG. 1, in embodiments, there are disclosed a centralized system 100 for agents and acquirers through which promotion, recommendation, negotiation, approval, verification, and accounting can be performed. More precisely, there is disclosed a centralized system 100 for the promotion and sale of products in which the server 102 may recommend potential purchasers (a selection of prospect acquirers) to an agent, help the agent to build a promotion strategy, transmit license proposals to rights owners, and provide the proprietor with information about the potential purchasers for the product he owns.

Still referring to FIG. 1, the centralized system 100 comprises a server 102 to which a local agent uploads, in a product database 104, a catalogue of products that are available for a type of transaction (sale, license). The local agents or any user can use client computers 150 having a connection (which is most often remote but may be physical) to the server 102 through the interface and communication module 110 (also called interface module), which allows an interface to be displayed on client computers 150 and data to be transmitted and received between the server 102 and the client computers 150. The product database 104, the acquirer directory 106, the proprietor directory, the search and processing engine 112 and the interface and communication module 110 may all be interconnected or in communication together to allow information to extracted and used.

For each product (which for example can be a book), the server 102 stores information in a product database 104. In an embodiment, the product database 104 is an intellectual work database, comprising information such as:
creator information (for example an author in the case of a book),
rights owner (i.e. provider publisher),
a category (for example in the case of a book, the category may be cooking, novel, kids' literature, etc.),
an abstract consisting of a brief description of the intellectual work,
sold languages/jurisdiction/country/format (languages/jurisdiction/country/format for which rights have been sold),
acquirer name for each sold language/jurisdiction/country/format,
available languages/jurisdiction/country/format (languages/jurisdiction/country/format for which rights are available), etc.

A corresponding agent connects to the server 102 from his client computer 150 through the interface and communication module 110 and creates a profile. In his profile, the corresponding agent can upload information concerning acquirers located in his territory in the acquirer directory 106 (which may be a publisher directory as in FIG. 1). The corresponding agent may consult a catalogue in the product database 104 to find the products on sale or for which licensing is available, or for which translation or subsidiary rights are available in his language/jurisdiction/country/format.

A proprietor or the representing agent can enter relevant information in the platform about a product to have it available for other users on the platform. Relevant information about the product may comprise a descriptive text or an image of the product, depending on what it is. However, it is more advantageous for the proprietor or their agent to identify prospect acquirers that are the most relevant and to send them specifically information about the product on sale or available for licensing.

The server 102 is adapted to recommend particular products to the corresponding agents or prospect acquirers, such as the most sold or the most recent intellectual works.

For each available intellectual work, the server 102 is further configured for recommending, to the foreign corresponding agent, which prospect acquirers may be interested in acquiring the product based on the history of previous transactions made by this prospect acquirer present in the corresponding agent profile. For example, if a particular acquirer has previously acquired rights for an intellectual work created by a given creator, the server 102 may recommend this particular acquirer to the corresponding agent if the intellectual work has been created by the same creator. Using the recommendations from the server 102, the corresponding agent identifies a list of acquirers that may be interested in acquiring the intellectual work rights. Of course, variances may exist: a prospect acquirer may be recommended to the foreign corresponding agent, to the local agent or directly to the proprietor, for example. Generally speaking, recommendations are provided in a push-manner to a party to suggest with whom (agent, owner, buyer . . . ) they should make business, using criteria such as the ones listed below.

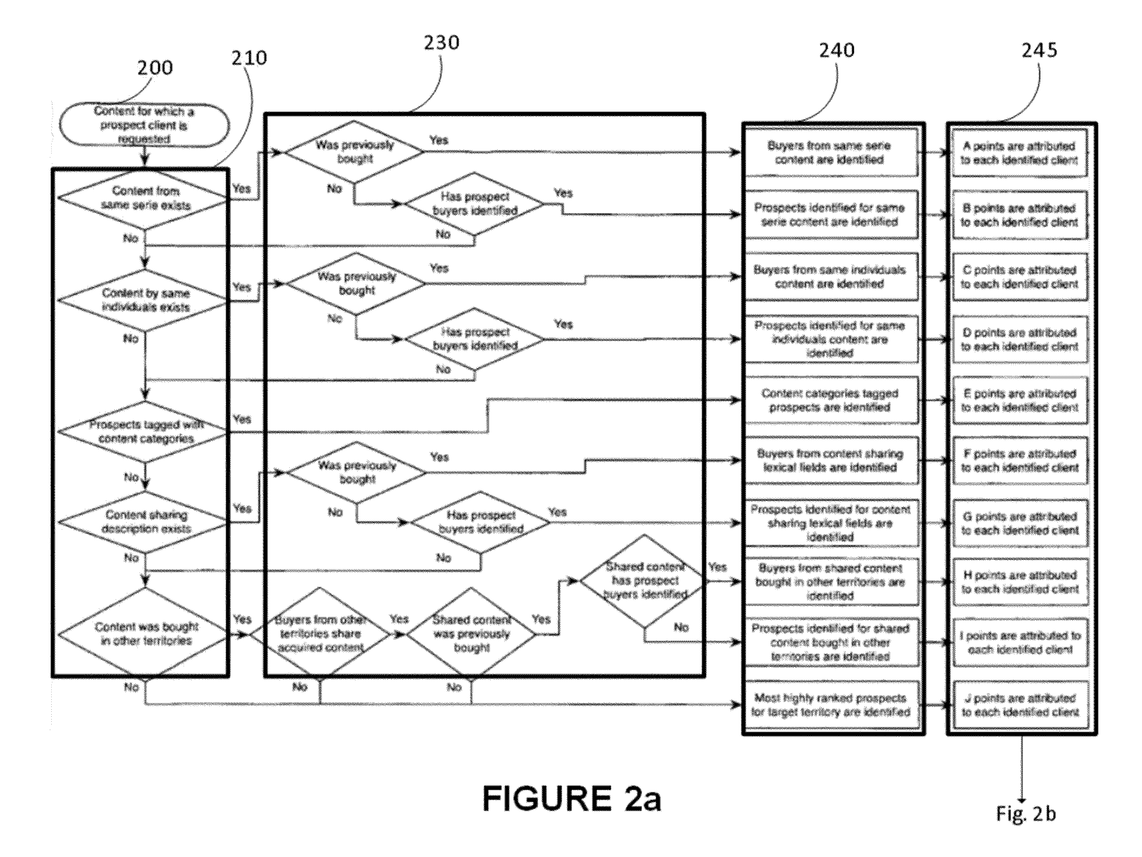

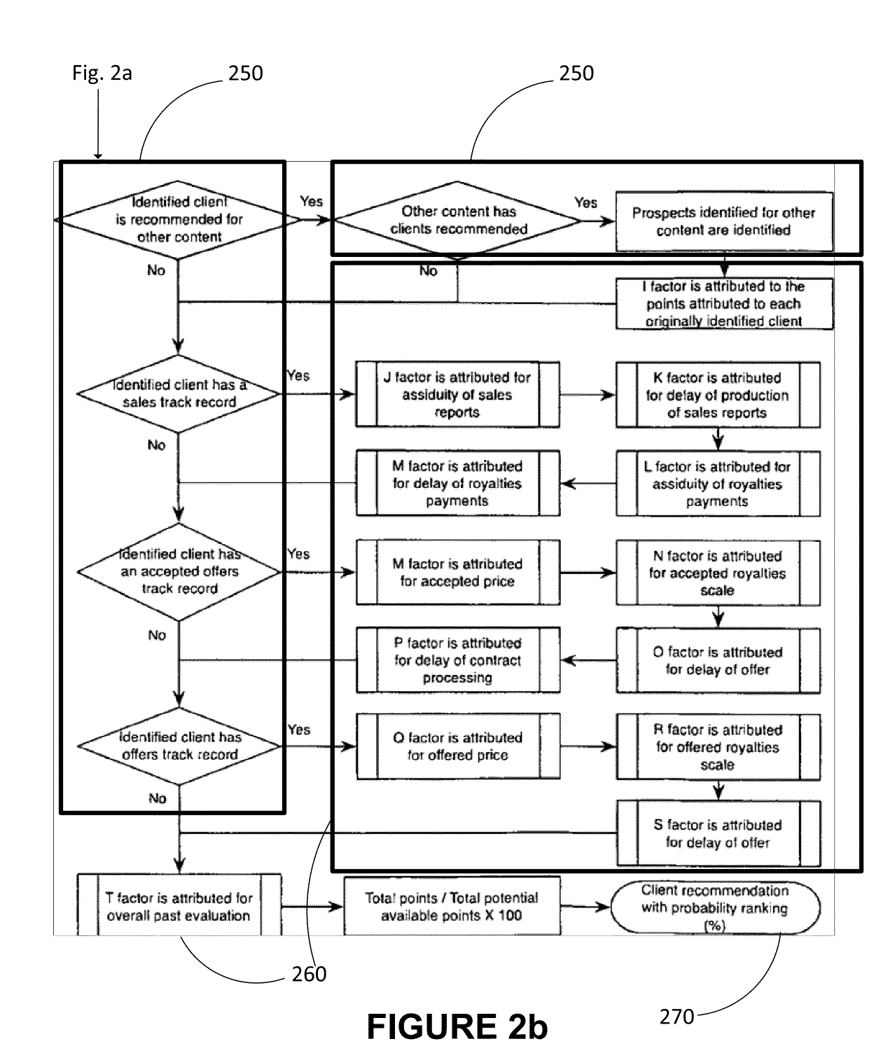

The reasoning/decision tree/criteria used by the server 102 to calculate a probability ranking which can be used to recommend acquirers is illustrated in FIGS. 2a and 2b.

According to an embodiment, an identification of the product 200 is performed. Then, the method goes through a series of primary decisions 210, comprising determining, for example, if products from a similar product line exist, if products from the same proprietor exist, if the prospect acquirers are tagged with a given product category, if product sharing description exists or if the product was bought in another territory and their buyers share acquired products. Once the primary decisions 210 have been made as in FIG. 2a, secondary decisions 230 may be performed. For example, it may be determined if the product has already been bought or if prospect acquirers have already been identified. Then, the prospect acquirer identification 240 occurs. Point attribution 245 may occur, giving a score of the prospect acquirer that may later be multiplied by a factor. An example of point attribution 245 is given below (Example 1).

Tertiary decisions 250 may be made (FIG. 2b), for example comprising determining if the identified prospect acquirer is recommended for another product and if such a product has clients recommended, and if the identified prospect acquirer has a sales track record, an accepted offers track record or an offers track record. After the tertiary decisions 250 are made, a factor attribution 260 occurs. The factor attribution 260 may be based on the assiduity of sales report, the delay of production of such a sales report, the delay or assiduity of royalty payments, the accepted/offered price or loyalties for other products bought by the prospect acquirer, the delay of offer or of contract processing, or the overall past evaluation. Finally, ranking 270 takes place, for example by taking the score or summing the points attributed at step 245, and multiplied by the factor computed at step 260 to generate a final ranking score or percentage.

Each ranking criterion may have a value so that prospect acquirers are ranked using their score that is calculated with their result for each criterion. An example (Example 1) is provided below on this matter. More generally, each decision from the primary, secondary and tertiary decisions may be considered as a ranking criterion, each ranking criterion being used to weigh a piece of the information about past transactions of the prospect acquirers to rank prospect acquirers.

The set of ranking criteria differ according to a given field (books, fine arts, patent licensing, etc.), but should comprise attributing a weight to the existence of a transaction (also referred to as “existing transaction”) by the prospect acquirer for a product line to which the product belongs, the existence of a transaction by the prospect acquirer with a proprietor of the product, or the existence of a transaction by the prospect acquirer for another product similar to the at least one product.

After the prospect acquirers are ranked, the selection of highly-ranked prospect acquirers (the highly-ranked prospect acquirers are those with a high rank, “high” being customizable but normally including the top scoring acquirers in the ranking, with possible exclusions) are displayed on the interface of the platform so the proprietor or his agent may contact them specifically. Therefore, recommendations are provided in a push-manner (they are automatically provided to the person who wishes to sell a product without asking for it).

The server 102 also allows the corresponding agent or the local agent to send promotional content about the intellectual work to the acquirers he previously identified. For example, using the search/processing engine 112 and the interface and communication module 110, the server 102 sends a promotional document identifying the appropriate agent as sender and comprising a link to download information about the content for which rights are available. The server 102, through its search/processing engine 112, is further configured for determining responsive acquirers, i.e. the server 102 determines which ones of the acquirers have accessed the promotional document and downloaded the information about the intellectual work. The list of responsive acquirers is provided to the corresponding agent who will subsequently focus his efforts on the responsive acquirers. The server 102 further offers the possibility to select the date at which the promotional content will be sent to each identified corresponding agent, thereby allowing the corresponding agent to build a strategy of promotion. The server 102 may also be configured to send reminders concerning the promotional content with a selected delay.

The server 102 works in much the same way for the local agent who sends promotional content about the intellectual works from the local producers he represents to the corresponding agents he previously identified.

A foreign (or even local in some cases) prospect acquirer may thus get to be interested by a product either because he received specific promotional content—because he was recommended to the proprietor or his agent who decided to send promotional content to this prospect acquirer,—either because he consulted the catalogue of available products. If interested, the prospect acquirer sends a purchase offer or license proposal to the corresponding agent. The offer/proposal comprises detailed information, such as the price, royalties, etc. In the case of a book for which the prospect acquirer wants to obtain rights on his country/language, the provided information could be an initial product release number (such as an initial printing number for a book), a retail pricing, royalties, the terms of the license, etc. The corresponding agent uploads the license proposal to the server 102, informing the local agent and the proprietor that a license proposal has been uploaded. The local agent and/or the proprietor may then access the license proposal via the server 102.

The server 102 is configured for providing the proprietor with information about the acquirer interested in acquiring the product in order to help the local agent or proprietor to make a decision. For example, the server 102 may provide information about previous transactions between the acquirer and proprietor, the average monetary amount offered by the acquirer in previous transactions, etc. The local agent may also provide the proprietor with recommendations via the server 102. Also, the agent or proprietor directory 108 comprises relevant information about past contracts and targets for the product per targeted market. This will be useful for the server 102 to provide an evaluation regarding a license proposal.

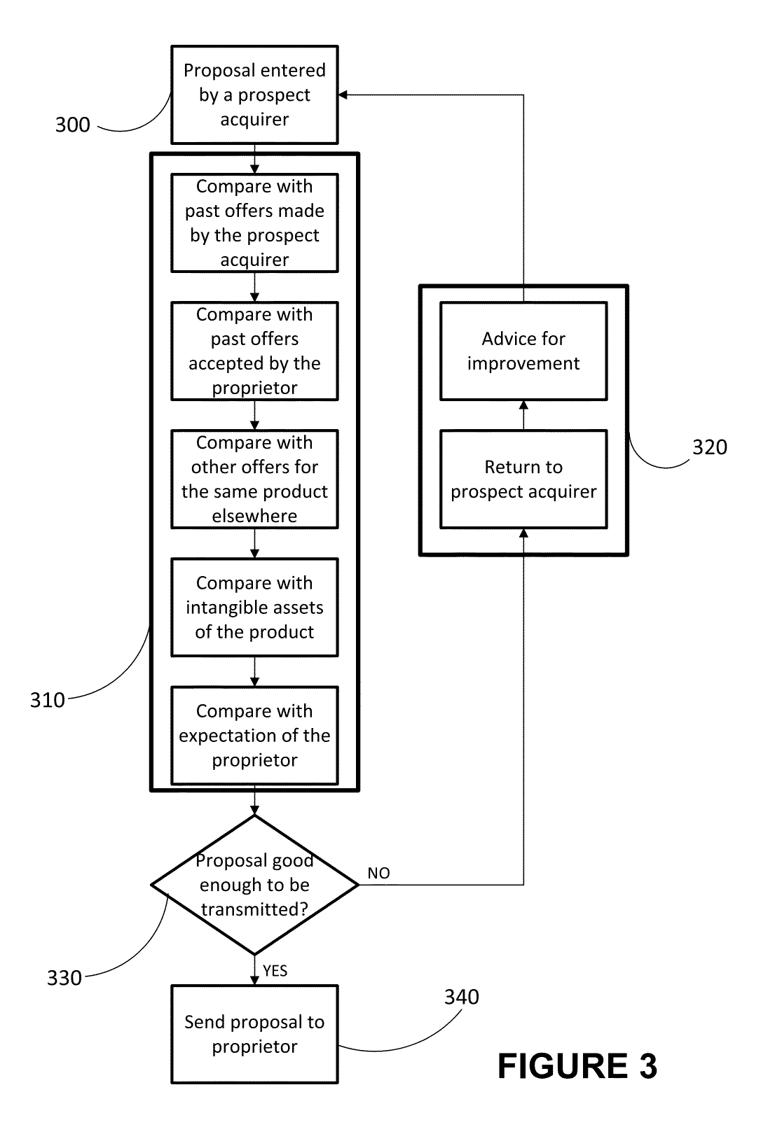

FIG. 3 illustrates various criteria that may be used to asses a proposal according to an embodiment. These assessment criteria comprise for example: a value of past transactions made by the prospect acquirer, a value of past transactions of the proprietor directory and which were accepted by the proprietor, or a value of the outcome expected by the proprietor for the transaction of the product. The assessment criteria are useful to benchmark the transaction proposal with a reference for comparison to determine if the transaction proposal is above or under an acceptable threshold that determines quality.

The proposal entry 300 in the platform through the interface is first made by the proposing prospect acquirer. Entry of relevant information of the transaction proposal in the platform should be performed, including the offered price (or royalties depending on the situation), offered for the product. Other information should be relevant depending on the context, such as the duration of the contract, the planned sales figures in the target market (for example if the product is licensed), the parties involved, etc.

A series of comparisons 310 then occurs on the basis of assessment criteria. The comparisons 310 may comprise comparing the present offer with past offers made by the prospect acquirer, with past offers accepted by the proprietor, with other offers for the same product in other markets, with the estimated value of intangible assets (perception of the value by the public, advertising done in the market, patents/trademarks/designs protecting the product, etc.), or with the expected price/royalties expected by the proprietor. These are more specific examples of the assessment criteria.

Scores may be given for each comparison in order to perform a good proposal evaluation 330. If, for example, the proposal does not reach a predetermined score, a turn-back 320 may occur. The prospect acquires receives a notification that the proposal he made is not good enough, with possible advice for improvement. Alternatively, transmission to the proprietor may be performed, with an accompanying message warning that the received proposal is not very good. If the proposal is considered as good enough in comparison with the assessment criteria, a proposal sending 340 occurs, so the proprietor (or the agent representing the proprietor) receives the proposal. Of course, criteria that are not relevant are not used (a decision is made before evaluating a criterion to determine if the given criterion is relevant or not depending on the prospect acquirer).

Evaluating a proposal may be useful for the prospect acquirer who sends a proposal. He may be warned automatically that the proposal is weak considering the criteria listed above. If the proposal is too weak, it will be sent back to the prospect acquirer and advice for improvement will be provided.

For the benefit of the proprietor receiving a proposal, an evaluation of the received proposal may be performed too. Considering the history of the prospect acquirer, the proprietor will know that the prospect acquirer usually makes better offers and the proprietor will know that he received a weak offer in comparison will similar transaction made by the prospect acquirers with other proprietors.

According to an embodiment, a messaging function is included in the platform to allow communication and, more specifically, negotiation between the parties. The messaging function can even include automatic reminders or follow-up messages. Every message received or sent will be connected to an email address to make sure no one misses a message.

### Multi-Level Software Architecture

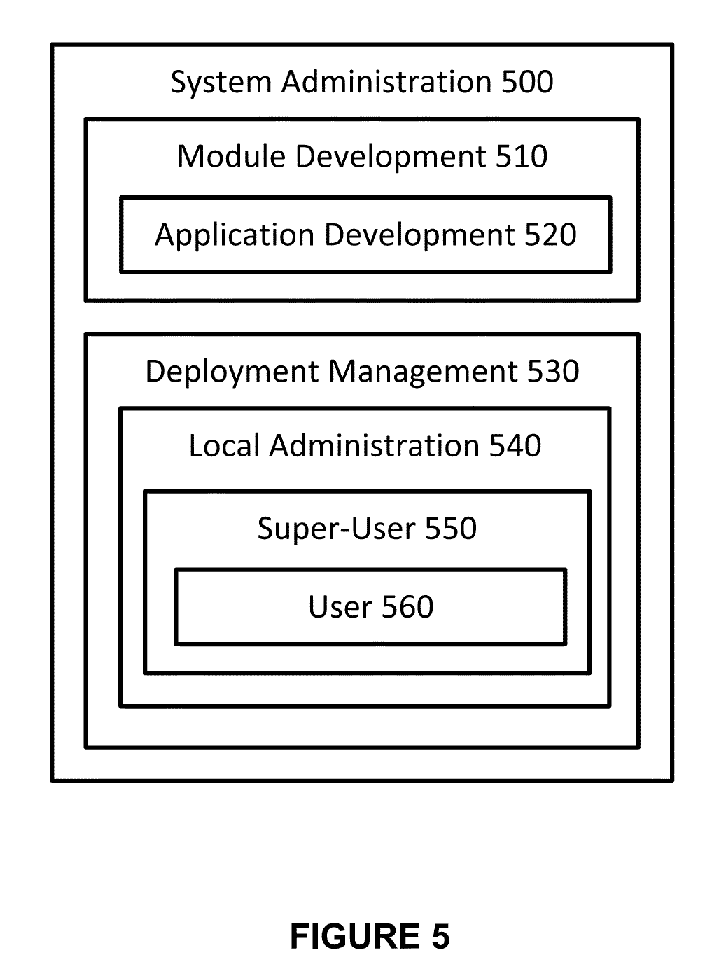

The platform may be implemented with a multi-level software architecture. The system 100 may thus comprise a multi-level permission module within the server 102 to deal with permissions (access to data). FIG. 5 shows an embodiment in which there are 7 levels, although it will be understood that other variants are possible within the scope of the subject matter disclosed herein.

In the embodiment illustrated in FIG. 5, the first level is a system administration 500 that is above all the other structures of the software. This first level is necessary if there is more than one application or business sector sustained by the platform. As explained above, the platform could be used for selling translation rights for a book, licensing a patent in a given country or selling real estate, etc. Such different business sectors (or modules) require different databases and deal with different contacts and are mostly separate. Nonetheless, some elements are recurrent and are thus managed in the widest level, and it is why the system administration 500 is common to all applications that can be found within it. User profiles are created and stored therein, and so are the statistics related to their profile. The messaging function is found at this level, as for the corresponding notification system (notifications may be sent by email to the user when something—like a message—happens in the platform).

The second level can be called module development 510. A module represents a business sector. For example, there may be a module for media rights, a module for patents, a module for real estate, etc., each module comprising its own databases, product lists with their characteristics, contacts, statistics, inventories, etc., that are relevant to the represented business sector. All data required for 1) recommendation of prospect acquirers and 2) evaluation of proposals are found at this level. These two functions (thoroughly described hereinabove) are thus implemented at this level.

A third level could be called application development 520. An application would be a module with a visual interface, allowing users to use the data and functions implemented for each module. If needed, a module may thus have various applications for different users depending on their type of subscription.

For a given application, a fourth level may exist, implemented within the system administration 500. This fourth level can be called deployment management 530, and it is where various options, permissions/prohibitions or parameters are set within the application depending on the subscription. For example, the application deployed for a company with a basic subscription may comprise everything but the databases, so the company may construct its own database with its own data accumulated throughout its history. A better subscription can allow a company to know elements of the repertory of all the users of the system. Another type of subscription may allow seeing sale statistics of prospect acquirers or proprietors from databases accumulated by everyone using the platform. For example, these statistics may be the results of the recommendation process as explained hereinabove and further exemplified below. For privacy, details of business made by a company may never be known by others, except by the agent representing this company. However, a voluntary sharing of data between the users of the platform is encouraged in order to improve the quality of the recommendations and evaluation done by the platform.

Other practical levels within the software may exist, for example a fifth level called local administrator 540. The local administrator 540 is the responsible in an organization for the subscription to the platform and can create other profiles within the organization and define roles and responsibilities for each profile. Other profiles include a sixth and a seventh level, called super-user 550 and user 560, who can use the system, the super-user 550 being allowed to create other user 560 profiles.

It will be understood that the number of levels may vary depending on the level of security or complexity that is desired. Depending on the number of distinctions made between people inside a subscribing organization, some levels could be added or deleted. A higher number of levels allows a greater distinction between users to make sure that only few people may modify the platform, or to make sure that users with a very cheap subscription do not have access to complete databases. Moreover, some users could choose not to share their own database, and a multi-level architecture is thus critical in maintaining the privacy of the data for these users. Finally, allowing a diversity of visual interfaces or modules (for different business sectors) also commands a multi-level software implementation.

As explained above in reference with FIG. 1, the platform may be implemented on a server 102 containing databases or directories, a search engine 112 and a communication module 110. This server 102 is preferably in communication with client computers 150 on which users access the platform through a user interface displayed or the client computers 150. The computing devices on which the platform may be implemented are described herein below.

### Hardware and Operating Environment

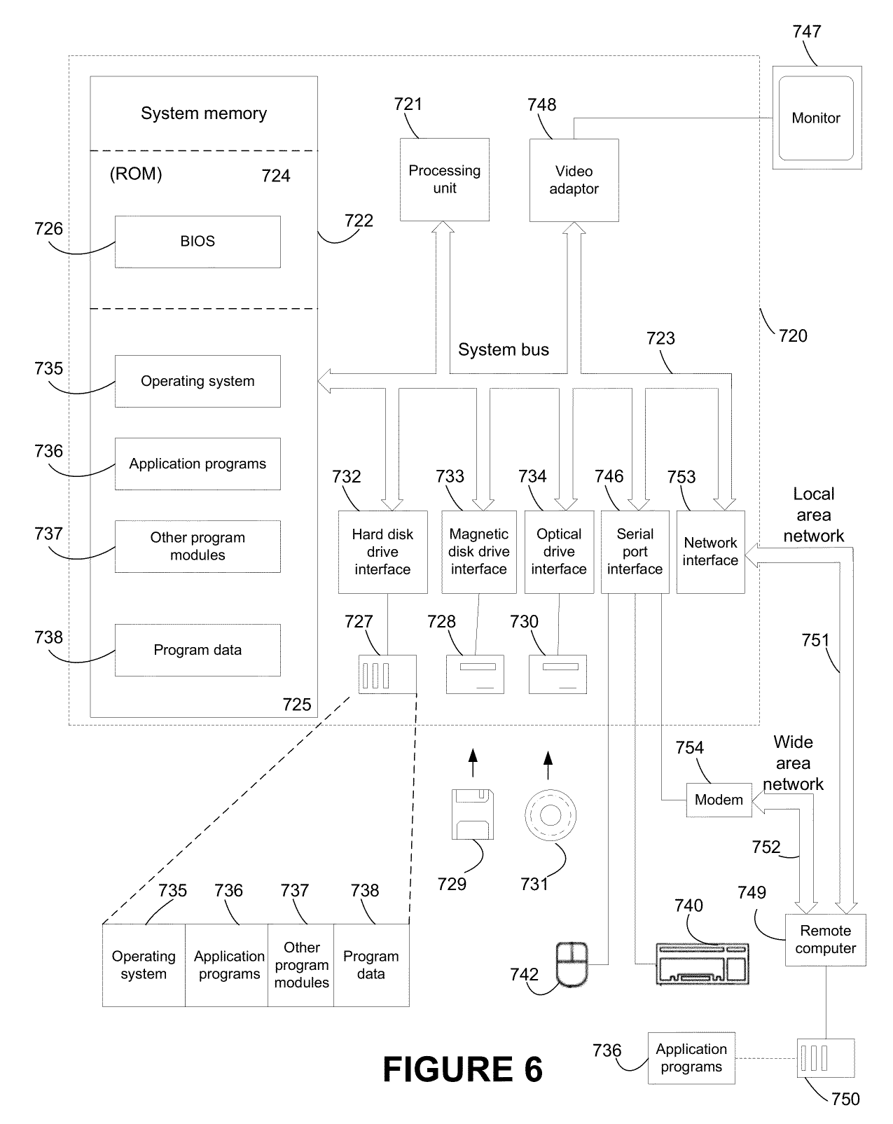

FIG. 6 illustrates an exemplary diagram of a suitable computing operating environment in which embodiments of the invention may be practiced. The following description is associated with FIG. 6 and is intended to provide a brief, general description of suitable computer hardware and a suitable computing environment in conjunction with which the embodiments may be implemented. Not all the components are required to practice the embodiments, and variations in the arrangement and type of the components may be made without departing from the spirit or scope of the embodiments.

Although not required, the embodiments are described in the general context of computer-executable instructions, such as program modules, being executed by a computer, such as a personal computer, a hand-held or palm-size computer, Smartphone, or an embedded system such as a computer in a consumer device or specialized industrial controller. Generally, program modules include routines, programs, objects, components, data structures, etc., that perform particular tasks or implement particular abstract data types.

Moreover, those skilled in the art will appreciate that the embodiments may be practiced with other computer system configurations, including hand-held devices, multiprocessor systems, microprocessor-based or programmable consumer electronics, network PCS, minicomputers, mainframe computers, cellular telephones, smart phones, display pagers, radio frequency (RF) devices, infrared (IR) devices, Personal Digital Assistants (PDAs), laptop computers, wearable computers, tablet computers, a device of the iPod, iPhone or iPad family of devices manufactured by Apple Computer, integrated devices combining one or more of the preceding devices, or any other computing device capable of performing the methods and systems described herein. The embodiments may also be practiced in distributed computing environments where tasks are performed by remote processing devices that are linked through a communications network. In a distributed computing environment, program modules may be located in both local and remote memory storage devices.

The exemplary hardware and operating environment of FIG. 5 includes a general purpose computing device in the form of a computer 720, including a processing unit 721, a system memory 722, and a system bus 723 that operatively couples various system components including the system memory to the processing unit 721. There may be only one or there may be more than one processing unit 721, such that the processor of computer 720 comprises a single central-processing unit (CPU), or a plurality of processing units, commonly referred to as a parallel processing environment. The computer 720 may be a conventional computer, a distributed computer, or any other type of computer; the embodiments are not so limited.

The system bus 723 may be any of several types of bus structures including a memory bus or memory controller, a peripheral bus, and a local bus using any of a variety of bus architectures. The system memory may also be referred to as simply the memory, and includes read only memory (ROM) 724 and random access memory (RAM) 725. A basic input/output system (BIOS) 726, containing the basic routines that help to transfer information between elements within the computer 720, such as during start-up, is stored in ROM 724. In one embodiment of the invention, the computer 720 further includes a hard disk drive 727 for reading from and writing to a hard disk, not shown, a magnetic disk drive 728 for reading from or writing to a removable magnetic disk 729, and an optical disk drive 730 for reading from or writing to a removable optical disk 731 such as a CD ROM or other optical media. In alternative embodiments of the invention, the functionality provided by the hard disk drive 727, magnetic disk 729 and optical disk drive 730 is emulated using volatile or non-volatile RAM in order to conserve power and reduce the size of the system. In these alternative embodiments, the RAM may be fixed in the computer system, or it may be a removable RAM device, such as a Compact Flash memory card.

In an embodiment of the invention, the hard disk drive 727, magnetic disk drive 728, and optical disk drive 730 are connected to the system bus 723 by a hard disk drive interface 732, a magnetic disk drive interface 733, and an optical disk drive interface 734, respectively. The drives and their associated computer-readable media provide nonvolatile storage of computer-readable instructions, data structures, program modules and other data for the computer 720. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 729, optical disk 731, ROM 724, or RAM 725, including an operating system 735, one or more application programs 736, other program modules 737, and program data 738. A user may enter commands and information into the personal computer 720 through input devices such as a keyboard 740 and pointing device 742. Other input devices (not shown) may include a microphone, joystick, game pad, satellite dish, scanner, touch sensitive pad, or the like. These and other input devices are often connected to the processing unit 721 through a serial port interface 746 that is coupled to the system bus, but may be connected by other interfaces, such as a parallel port, game port, or a universal serial bus (USB). In addition, input to the system may be provided by a microphone to receive audio input.

A monitor 747 or other type of display device is also connected to the system bus 723 via an interface, such as a video adapter 748. In one embodiment of the invention, the monitor comprises a Liquid Crystal Display (LCD). In addition to the monitor, computers typically include other peripheral output devices (not shown), such as speakers and printers. The monitor may include a touch sensitive surface which allows the user to interface with the computer by pressing on or touching the surface.

The computer 720 may operate in a networked environment using logical connections to one or more remote computers, such as a remote computer 749. These logical connections are achieved by a communication device coupled to or a part of the computer 720; the embodiment is not limited to a particular type of communications device. The remote computer 749 may be another computer, a server, a router, a network PC, a client, a peer device or other common network node, and typically includes many or all of the elements described above relative to the computer 720, although only a memory storage device 750 has been illustrated in FIG. 6. The logical connections depicted in FIG. 6 include a local-area network (LAN) 751 and a wide-area network (WAN) 752. Such networking environments are commonplace in offices, enterprise-wide computer networks, intranets and the Internet.

When used in a LAN-networking environment, the computer 720 is connected to the local network 751 through a network interface or adapter 753, which is one type of communications device. When used in a WAN-networking environment, the computer 720 typically includes a modem 754, a type of communications device, or any other type of communications device for establishing communications over the wide area network 752, such as the Internet. The modem 754, which may be internal or external, is connected to the system bus 723 via the serial port interface 746. In a networked environment, program modules depicted relative to the personal computer 720, or portions thereof, may be stored in the remote memory storage device. It is appreciated that the network connections shown are exemplary and other means of and communications devices for establishing a communications link between the computers may be used.

The hardware and operating environment in conjunction with which embodiments of the invention may be practiced has been described. The computer in conjunction with which embodiments of the invention may be practiced may be a conventional computer a hand-held or palm-size computer, a computer in an embedded system, a distributed computer, or any other type of computer; the invention is not so limited. Such a computer typically includes one or more processing units as its processor, and a computer-readable medium such as a memory. The computer may also include a communications device such as a network adapter or a modem, so that it is able to communicatively couple other computers.

The present invention will be more readily understood by referring to the following examples which are given to illustrate the invention rather than to limit its scope.

### Example 1

### Book Rights Platform

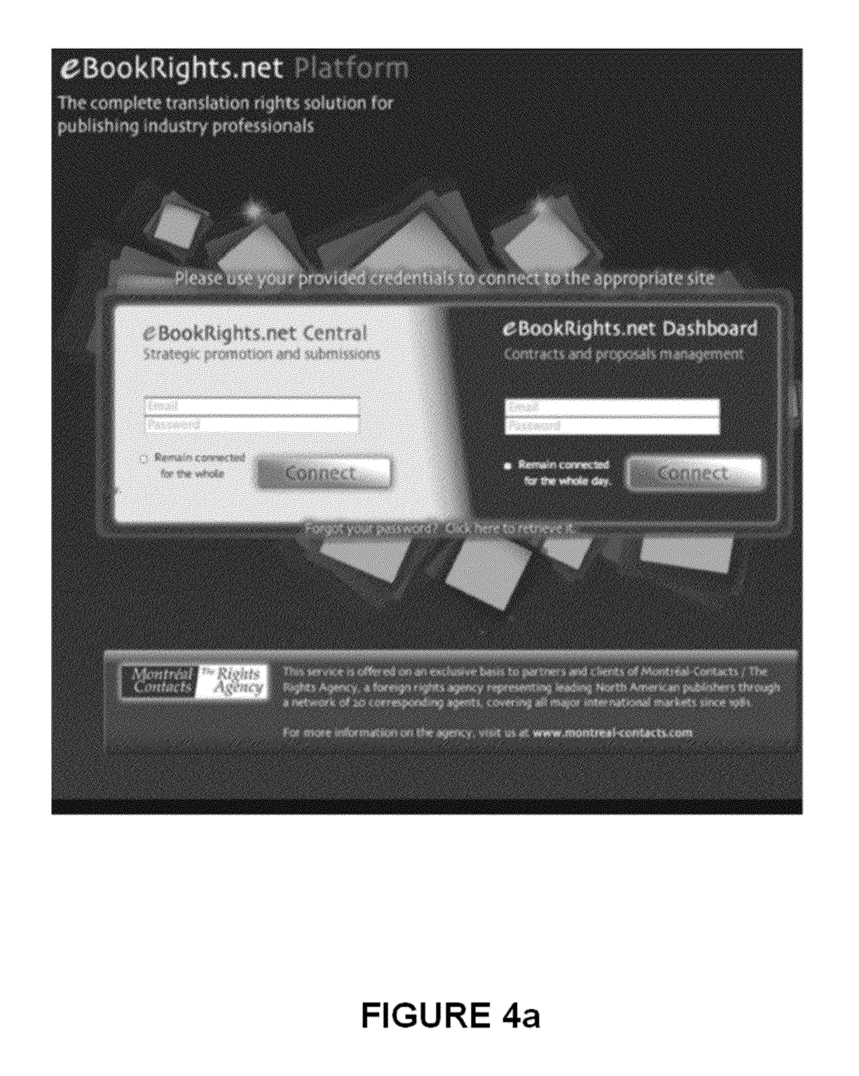

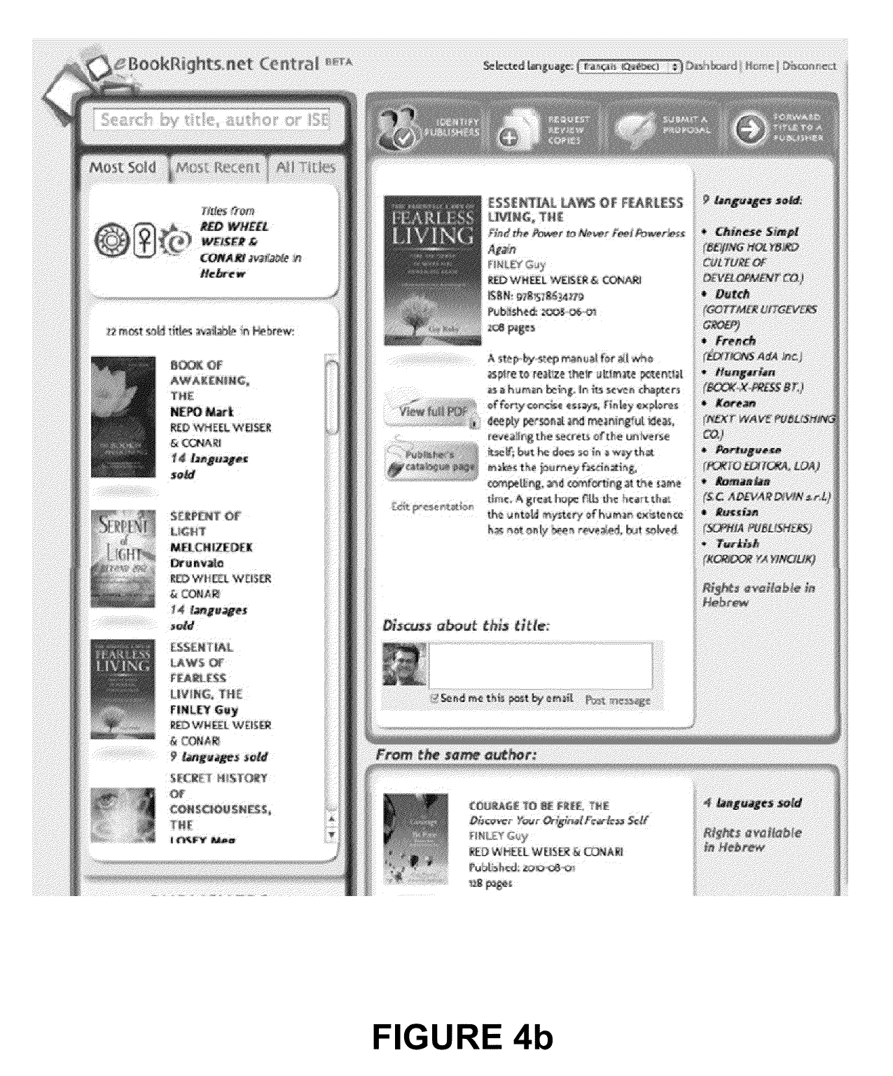

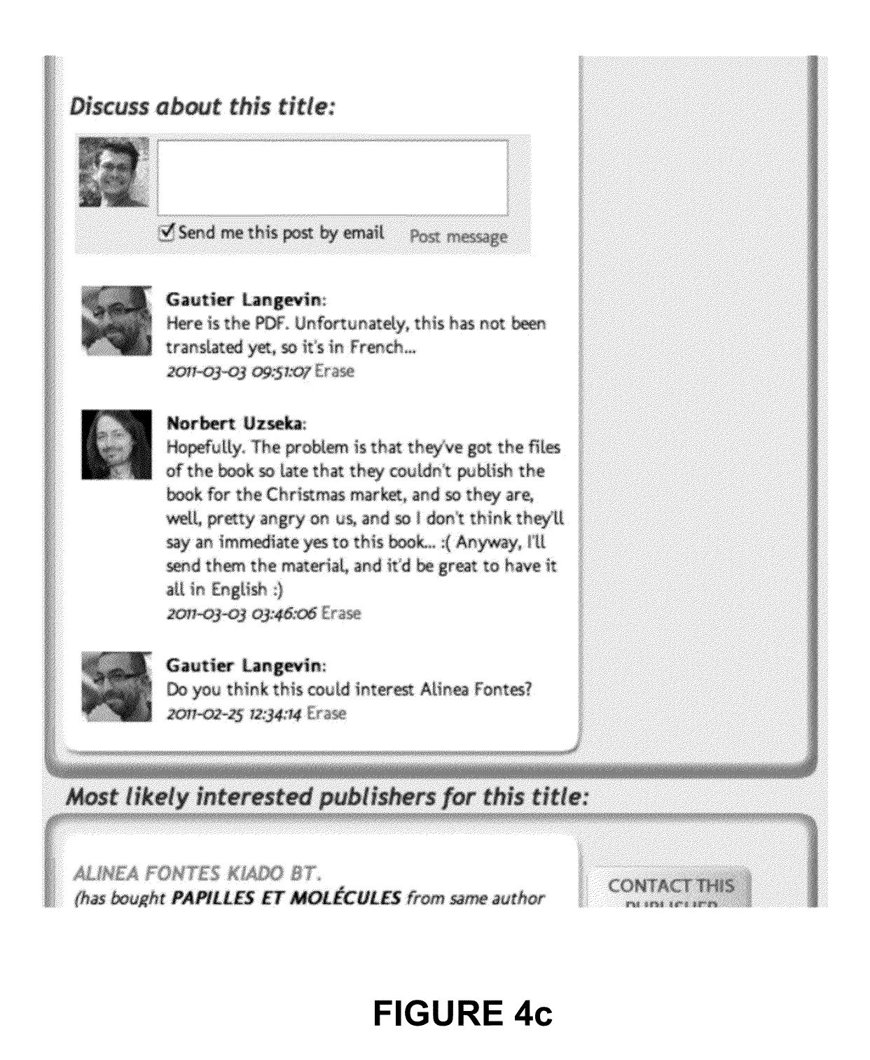

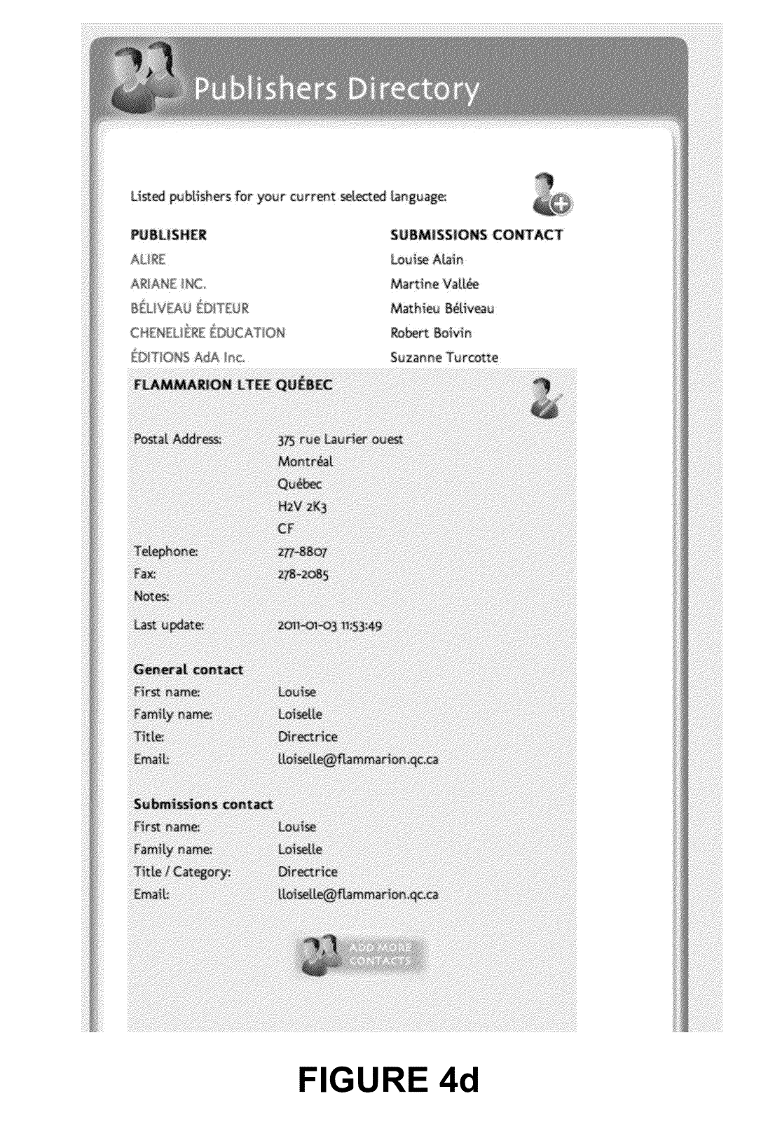

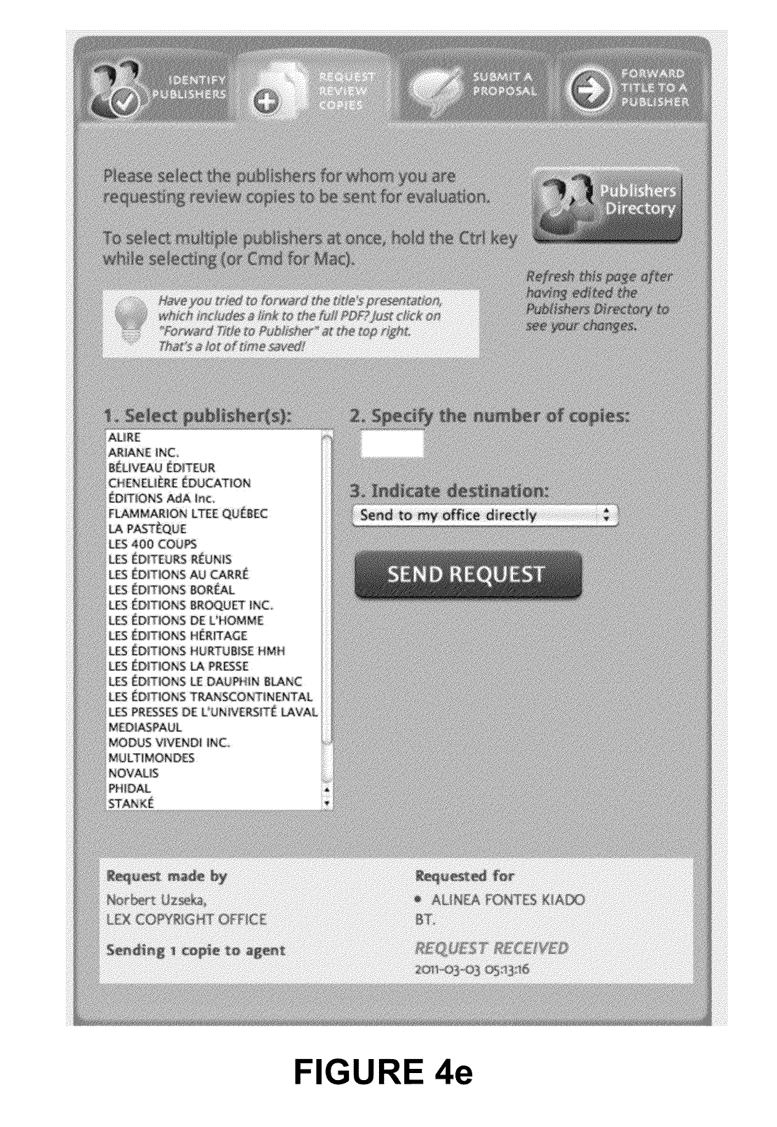

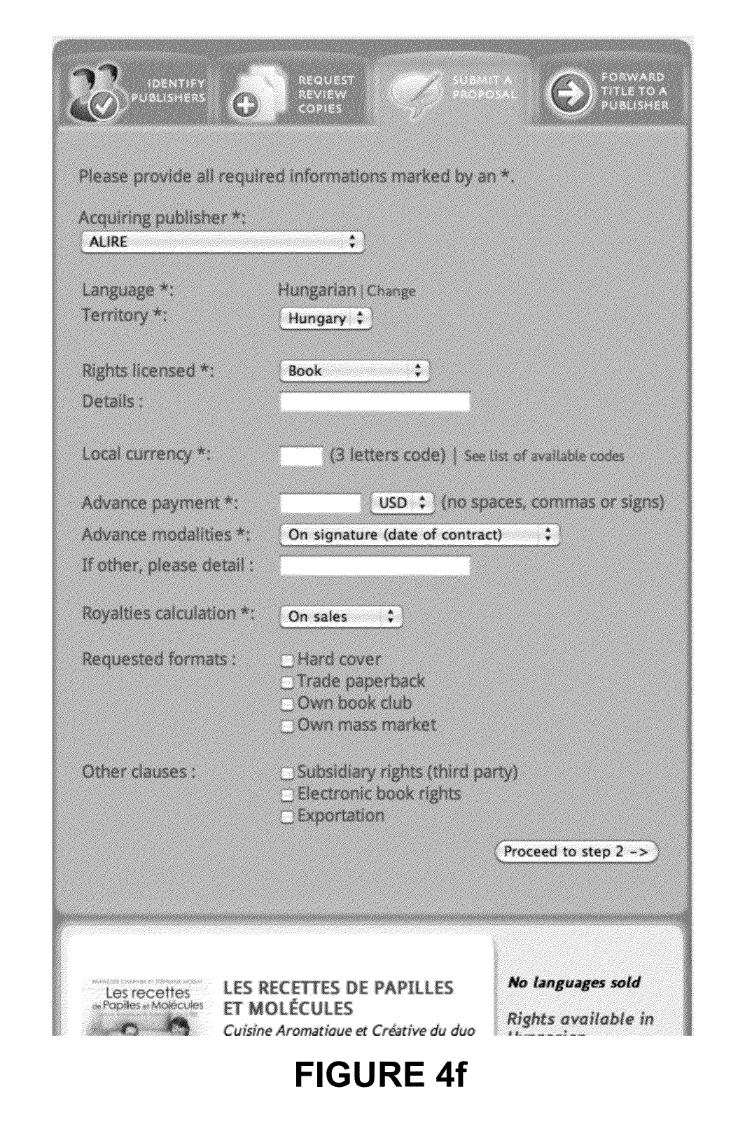

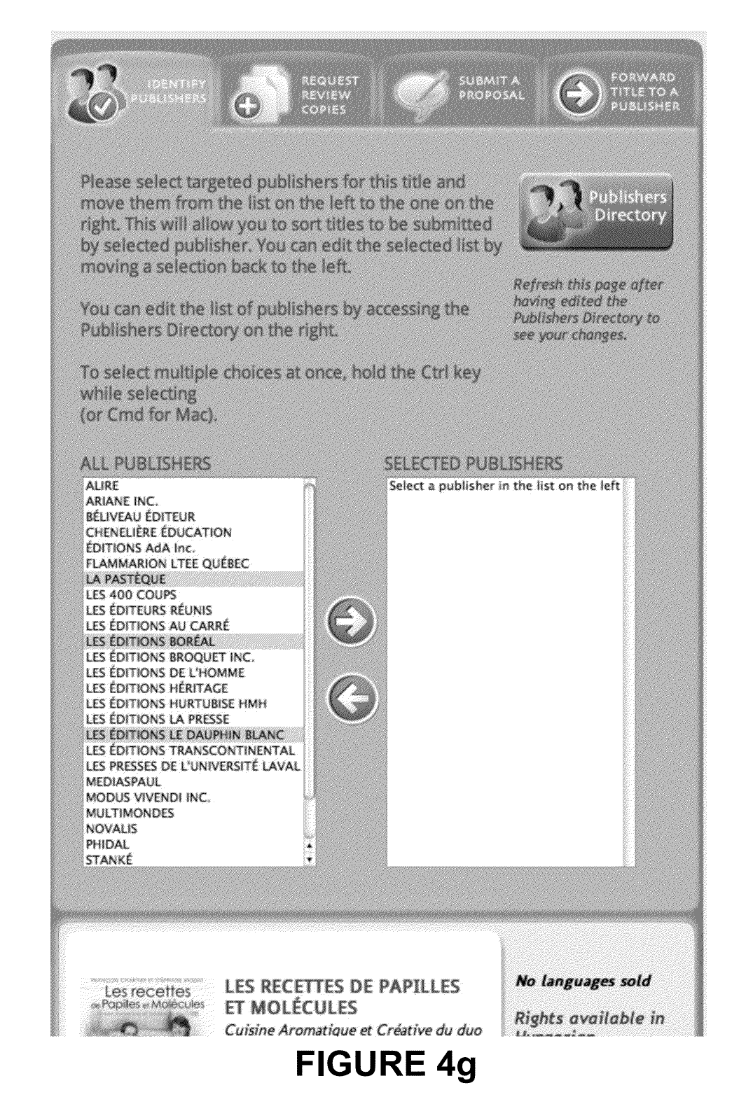

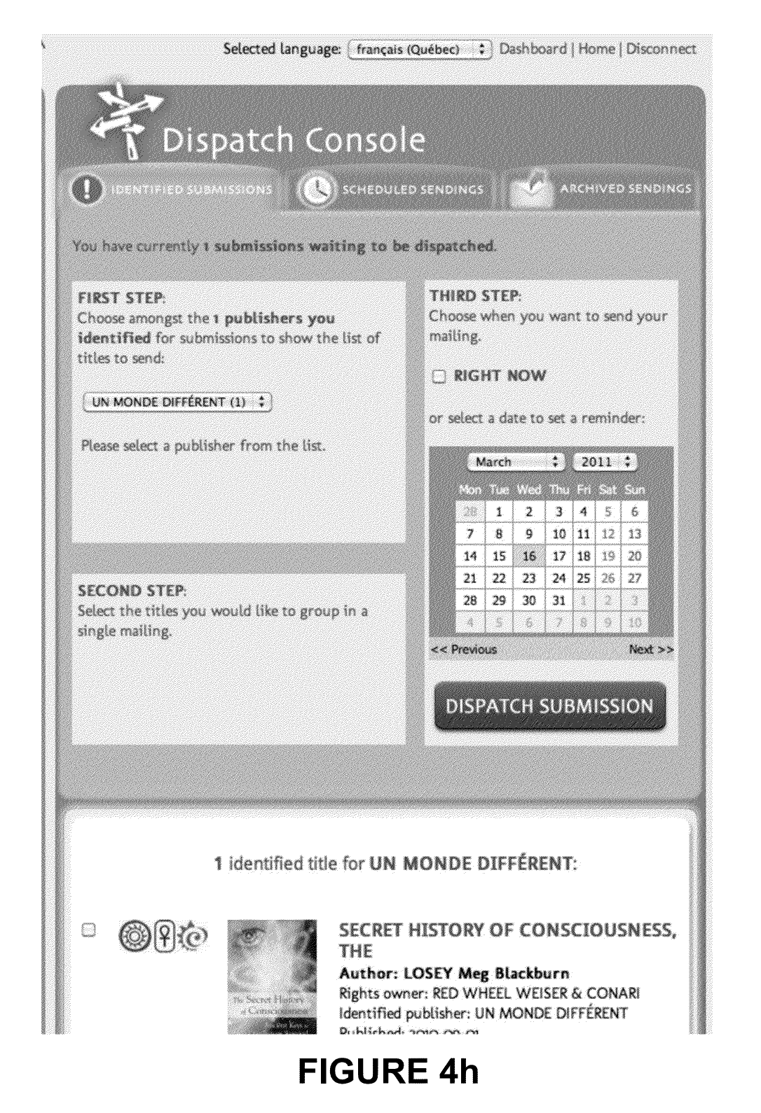

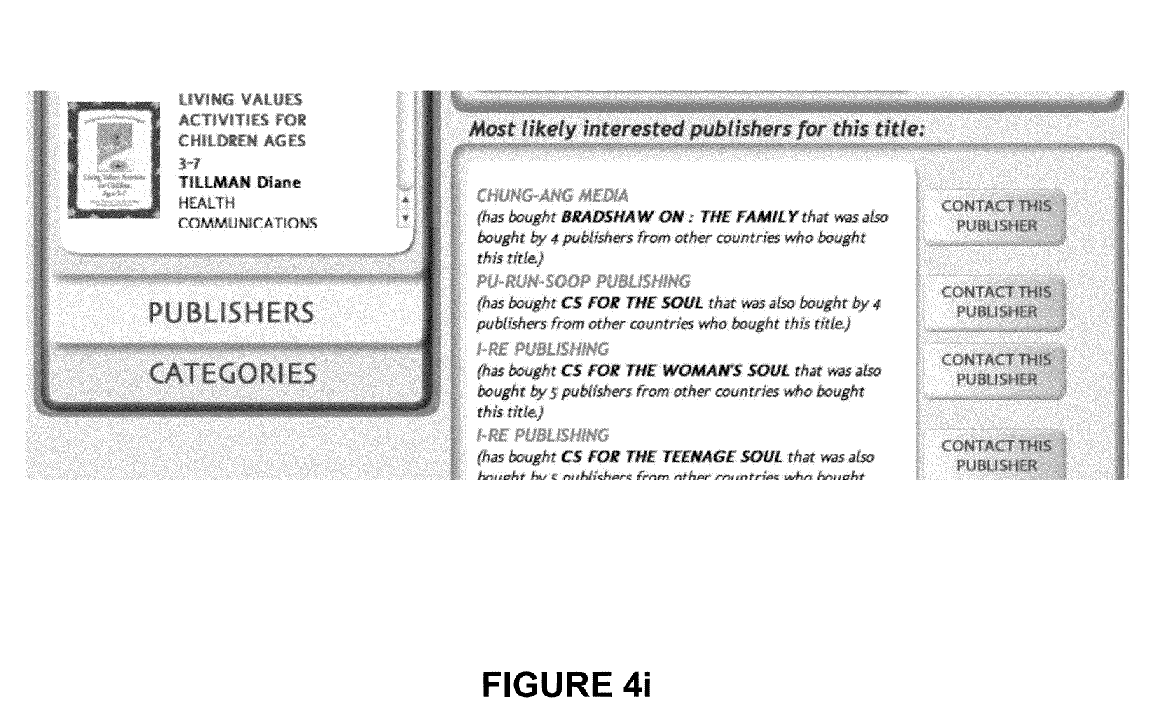

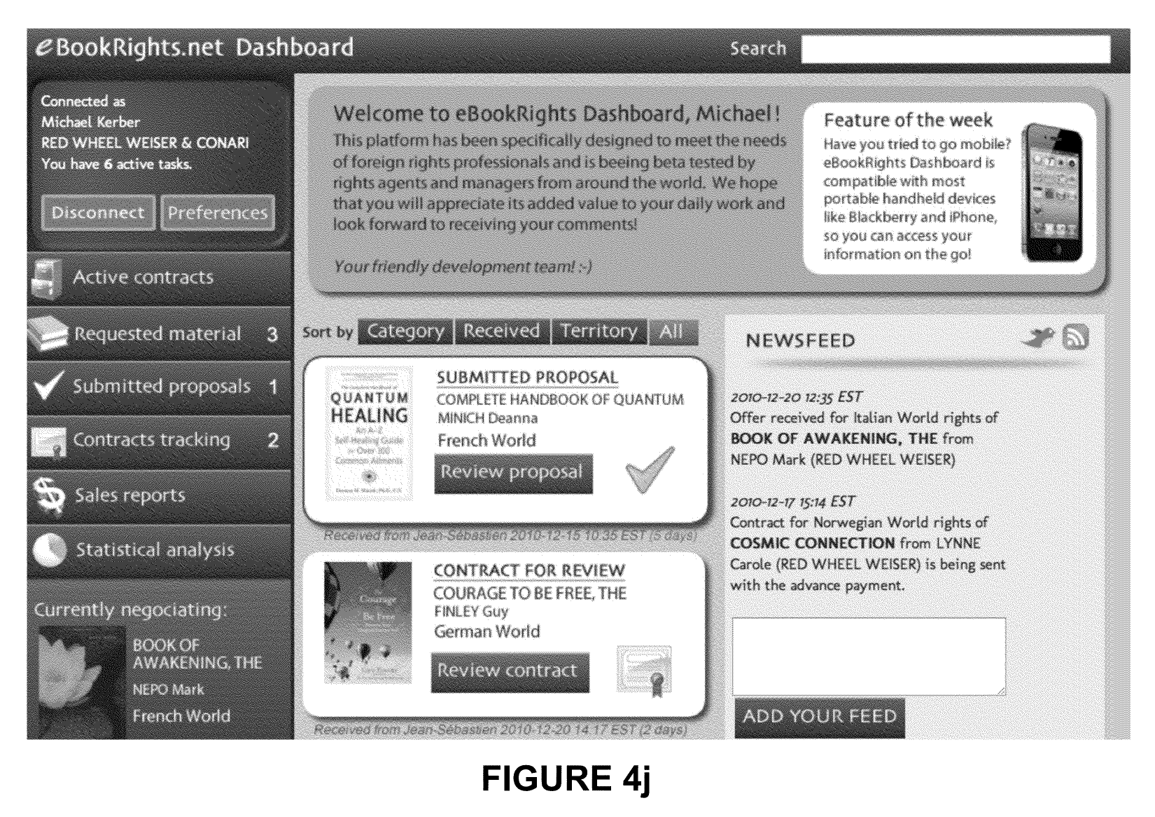

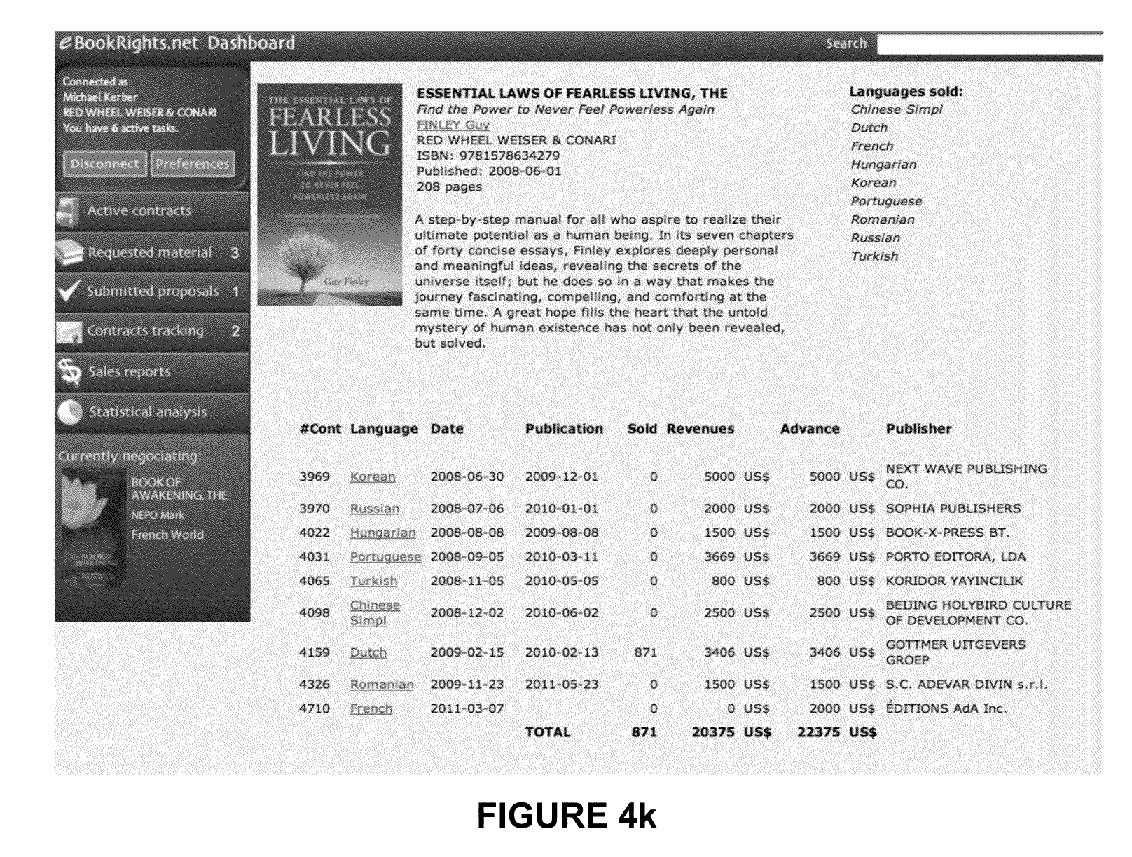

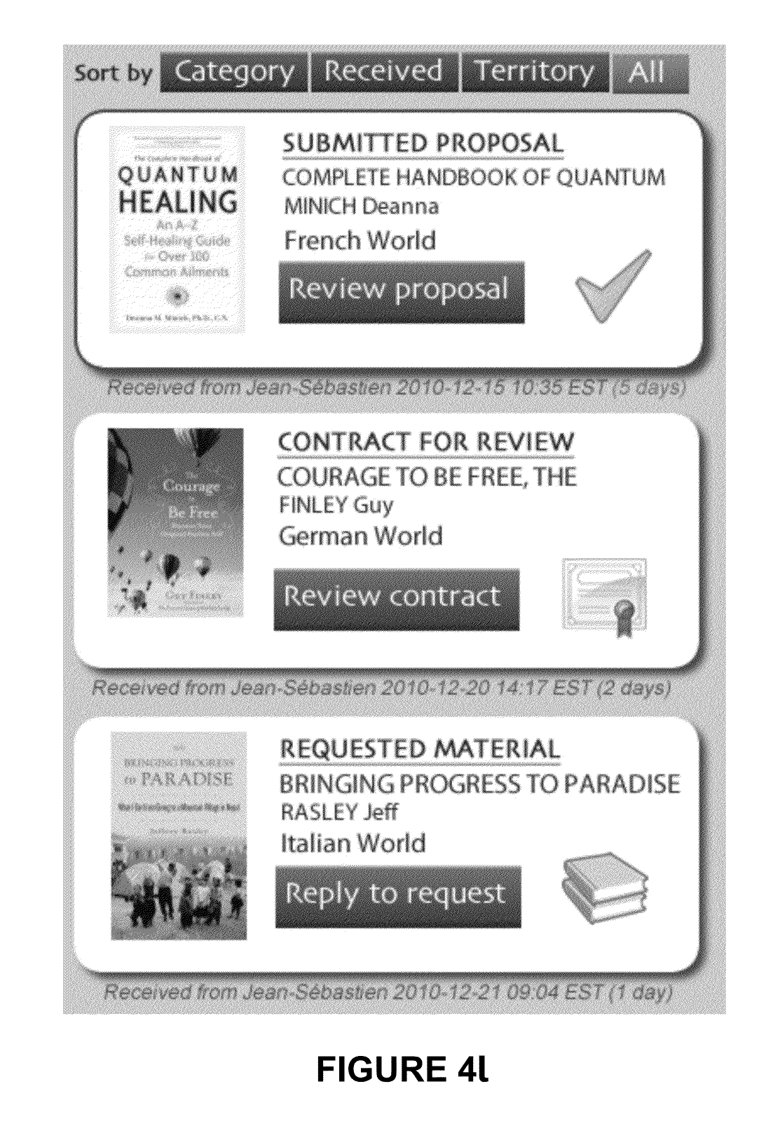

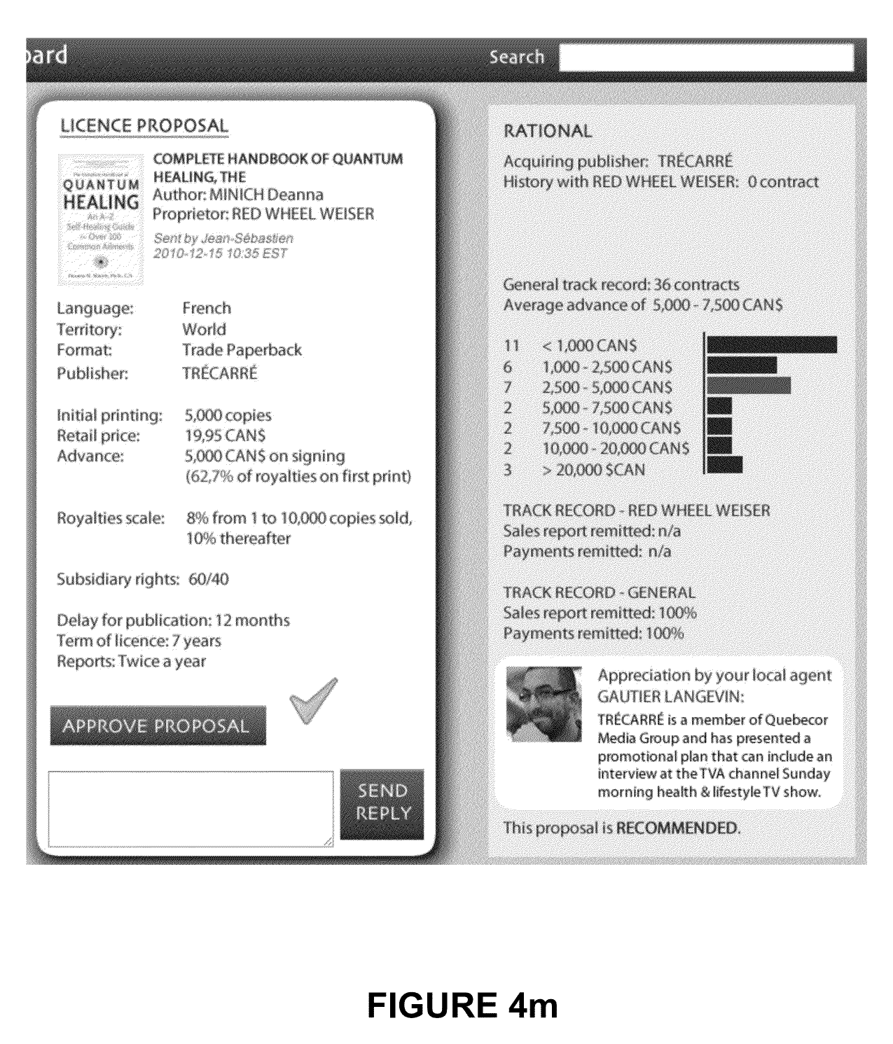

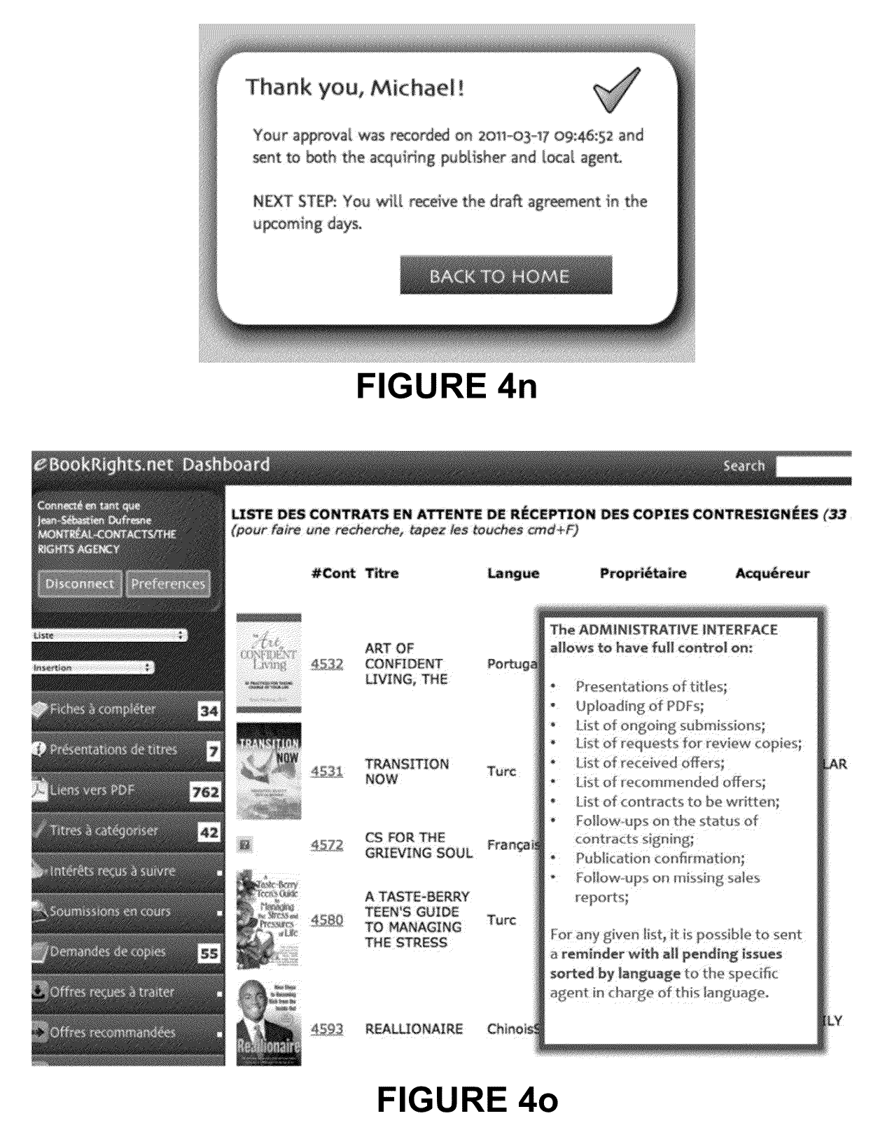

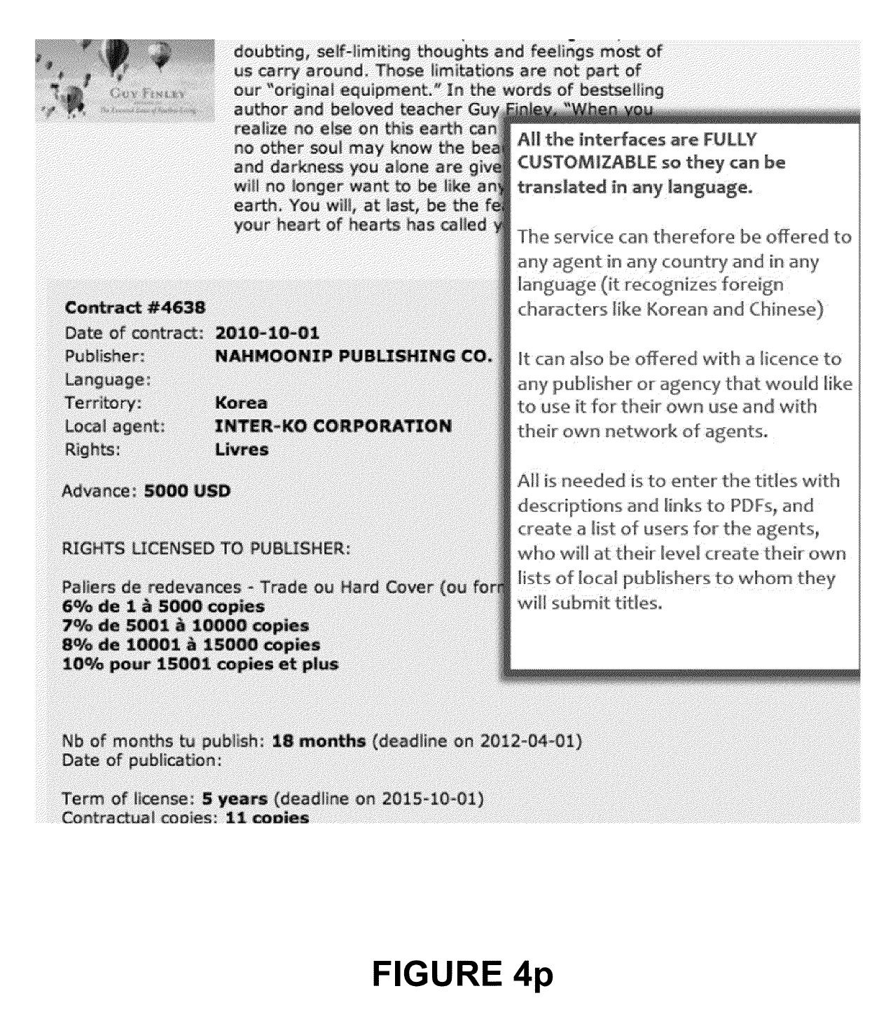

Now referring to FIG. 4a, there is shown an example of a welcoming screen of a web based platform for publishing industry professionals that facilitates sharing of information about translation or subsidiary rights transactions across all stages of the process:
Promotion,
Negotiation,
Recommendation,
Approval,
Contracts,
Processing,
Verification,
Accounting.

The platform is composed of two interfaces,

1—one for foreign agents promoting titles to local publishers who plan to acquire translation rights and sell locally their language version of the book; and

2—one for rights owners following cases and approving offers.

There is shown an example of a CATALOGUE INTERFACE in FIG. 4b which allows the agent to easily and quickly review the available titles with all key information.

A DISCUSSION PANEL allows the agents to correspond directly between themselves and keep track of all information and requests related to a specific title in a specific language (FIG. 4c).

An example of a PUBLISHER DIRECTORY is shown in FIG. 4d which gives the agent direct control on the list of publishers used by the system.

FIG. 4e illustrates the REQUEST REVIEW COPIES function which allows to request easily a specific number of review copies of a title to be sent by post to selected publishers.

The SUBMIT A PROPOSAL function makes the previous back and forth process easy. All requested information necessary in order to fully evaluate a proposal for recommendation can be entered by the agent or acquiring publisher right from the online form. The information is processed through the database and an automated pre-evaluation is conducted by the system according to several criteria (FIG. 4f).

When comes time to SUBMIT PROMOTIONAL CONTENT about a title to a potential acquiring publisher, two possibilities are offered to the agent:

1. Send one title presentation as stand Alone, or

2. Send multiple titles Presentations.

In all cases, a tracking is kept of which publisher actually opened the received messages and which one downloaded the linked PDFs. This information is invaluable for the agents to better concentrate their energies on responsive publishers (FIG. 4g).

FIG. 4h illustrates the DISPATCH CONSOLE. All selected publishers can be retrieved in the DISPATCH CONSOLE where any agent can:

1. Select a targeted publisher to view a list of titles for which it was identified;

2. Choose amongst the list of titles the ones to be grouped in a single mailing;

3. Decide whether to send the mailing at that moment or plan for a future date.

It is therefore possible for the agent to plan a strategy of submissions and be sure to have submission mailings scheduled on a regular basis throughout the year for every potential acquiring publisher with customized selections. Strategic planning of submissions also allows to make sure that all represented publishers are properly covered by efficiently managing the diversity of every selection in order to have titles from every represented publishers sent. All scheduled mailings can be edited at any time in order to replan according to newly entered titles or recent added information.

Also on the DISPATCH CONSOLE there is shown in FIG. 4h, that an email with all presentation information of the selected titles may be sent to the selected addresses automatically, according to the submissions contacts coordinates entered in the publishers' directory, with the agent's email as the sender and reply-to.

FIG. 4i illustrates the criteria for the platform which suggests publishers to contact with just one click based on several criteria (in order of importance).

Another useful section of this site is the DASHBOARD, intended for the rights owners in order to manage the offers received and the ongoing Contracts (FIG. 4j).

FIG. 4k illustrates available functions which include search of the database by title, author or ISBN code, to access the complete sales statistics of any given title.

A useful feature is the easy TASKS TRACKING list that highlights all pending tasks that require an action from the publisher (FIG. 4l).

Offers received by the local agents and recommended for approval are displayed, and the publisher can REVIEW AND APPROVE THE PROPOSAL (FIG. 4m).

As for all other operations, the most that is needed from the publisher is a simple click in order to confirm his Approval (FIG. 4n).

The ADMINISTRATIVE INTERFACE shown in FIG. 4o allows one to have full control over:
Presentations of titles;
Uploading of PDFs;
List of ongoing submissions;
List of requests for review copies;
List of received offers;
List of recommended offers;
List of contracts to be written;
Follow-ups on the status of contracts signing;
Publication confirmation;
Follow-ups on missing sales Reports.

All the interfaces are FULLY CUSTOMIZABLE so they can be translated in any Language (FIG. 4p).

### Example 2

### Probability Ranking Calculation for a Client

Now referring to FIGS. 2a and 2b, an example of the probability ranking calculation for a client/acquirer is illustrated. The decision tree shown in FIGS. 2a and 2b is used by the server to calculate a probability ranking which can be used to recommend acquirers.

The first (left) part of the decision tree is used to attribute a number of points to each identified client based on the content of the work. The second (right) side of the decision tree is used to factor the number of points according to the evaluation of the identified client.

In this example, the following points may be attributed:
A points: 100;
B points: 90;
C points: 80;
D points: 70;
E points 60;
F points: 50;
G points: 40;
H points: 30;
I points: 20; and
J points: 10.

Still, in this example, the following factors may be attributed:
I factor: 1.2
J factor: 1.2
K factor: 0.8
L factor: 1.2
M factor (delay of royalty): 0.8
N factor (accepted price): 1.2
O factor: 0.8
P factor: 0.8
Q factor: 1.2
R factor: 1.2
S factor: 0.8
T factor: 1.2

Still in this example, the maximum number of points is 430. In the present example, buyers from content sharing lexical fields are identified. The server would therefore navigate through the first portion of the decision tree to attribute 50 points (F points).

The prospective client is not recommend for other content, he has a sales track record which shows that he is assiduous in reporting sales (J factor: 1.2), he is assiduous in royalty payments (L factor: 1.2), and he is reported to delay offers (S factor: 0.8). In this case, his total score would be 57.6 (50×1.2×1.2×0.8) out of a total possibility of 430 which would result in a probability ranking of 13.4% ((57.6/430)×100). The server will therefore rank the potential acquirers/clients based on a comparison of the probability rankings for each and present the information to the user.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A platform configured to recommend in a push manner a selection of prospect acquirers for at least one product for a target market, the platform comprising:
a product database containing relevant information on the at least one product for the target market;
an acquirer directory with information about past transactions of prospect acquirers;
a search engine, in communication with the product database and with the acquirer directory, configured to scan the acquirer directory in a push manner to rank prospect acquirers for the at least one product for the target market using a set of ranking criteria, each ranking criterion being used to weigh a piece of the information about past transactions of the prospect acquirers to rank prospect acquirers; and
an interface, in communication with a client computer and with the search engine, configured to display in a push manner a selection of highly-ranked prospect acquirers.

2. The platform of claim 1, wherein the set of ranking criteria comprise at least one of:
an existing transaction by the prospect acquirers for a product line to which the at least one product belongs;
an existing transaction by the prospect acquirers with a proprietor of the at least one product; and
an existing transaction by the prospect acquirers for another product similar to the at least one product.

3. The platform of claim 1, wherein the product database comprises at least one of a good, a service and an intangible asset.

4. The platform of claim 1, wherein the product database comprises intellectual work.

5. The platform of claim 4, wherein the intellectual work is at least one of a book, a piece of music, a song, a work of art, a TV show, a theater play, a movie, and a game.

6. The platform of claim 1, wherein the target market comprises at least one of a territory, a language and a format.

7. The platform of claim 1, wherein the relevant information on the at least one product comprises at least one of an image representing the at least one product and a descriptive text describing the at least one product.

8. The platform of claim 1, further configured to evaluate a transaction proposal, for the target market, made by a proposing prospect acquirer for the at least one product belonging to a proprietor, wherein the interface is further configured to allow entry of relevant information of the transaction proposal for the at least one product, the platform further comprising:
a proprietor directory with information about past transactions of the proprietor and with information about an outcome expected by the proprietor for the transaction proposal for the at least one product for the target market; and
a processing engine, in communication with the interface, with the product database and with the acquirer directory, configured to automatically evaluate the transaction proposal, wherein the relevant information of the transaction proposal is compared with the information stored in the acquirer directory and in the proprietor directory on the basis of assessment criteria, thereby providing a recommendation about the transaction proposal.

9. The platform of claim 8, wherein the relevant information of the transaction proposal comprises an offered price for the at least one product.

10. The platform of claim 8, further comprising a multi-level permission module for determining which information about past transactions from the proprietor directory and from the acquirer directory a user is allowed to consult or to modify depending upon a status of the user in the multi-level permission module.

11. The platform of claim 8, wherein the assessment criteria comprise at least one of:
a value of past transactions made by the proposing prospect acquirer;
a value of past transactions of the proprietor directory and which were accepted by the proprietor; and
a value of the outcome expected by the proprietor for the transaction proposal of the at least one product.

12. The platform of claim 8, wherein at least one of the prospect acquirers and of the proprietor comprises a representing agent.

13. A method for identifying a transaction opportunity and assessing a transaction proposal for at least one product, the method comprising:
receiving an entry of a product from a proprietor of the at least one product in a product database;
ranking prospect acquirers among those listed in an acquirer directory, the ranking being based on ranking criteria;
selecting highly-ranked prospect acquirers; and
sending a message about the at least one product to the highly-ranked prospect acquirers.

14. The method of claim 13, wherein receiving an entry from a proprietor comprises receiving an entry from an agent representing the proprietor.

15. The method of claim 13, wherein sending a message to the highly-ranked prospect acquirers comprises sending a message to agents representing the highly-ranked prospect acquirers.

16. The method of claim 13, further comprising:
receiving a transaction proposal for the at least one product by at least one of the highly-ranked prospect acquirers;
determining if the transaction proposal is above an acceptable threshold; and
if the transaction proposal is determined to be above the acceptable threshold, transmitting the transaction proposal to the proprietor.

17. The method of claim 16, further comprising automatically sending the transaction proposal back to the at least one of the highly-ranked prospect acquirers with advice for improvement if the transaction proposal is determined to be under the acceptable threshold.

18. The method of claim 16, wherein receiving a transaction proposal by at least one of the highly-ranked prospect acquirers comprises receiving a transaction proposal by an agent representing at least one of the highly-ranked prospect acquirers.

19. The method of claim 16, wherein transmitting the transaction proposal to the proprietor comprises transmitting the transaction proposal to an agent representing the proprietor.

20. A system for identifying a transaction opportunity and assessing a transaction proposal for at least one product, the system comprising:
a server including
an interface module configured to allow entry of relevant information of the at least one product by a proprietor of the at least one product, and entry of relevant information of the transaction proposal by a proposing prospect acquirer for the at least one product for a target market;
an acquirer directory with information about past transactions of the proposing prospect acquirer;
a proprietor directory with information about past contracts of the proprietor; and
a search engine configured for at least one of
scanning the acquirer directory in a push manner to rank prospect acquirers listed in the acquirer directory for the at least one product for the target market using a set of ranking criteria; and
automatically evaluating a transaction proposal by the proposing prospect acquirer, wherein the relevant information of the transaction proposal is compared with the information stored in the acquirer directory and in the proprietor directory on the basis of assessment criteria, thereby providing a recommendation about the transaction proposal; and
a client computer for enabling access of a user to the system by communicating with the interface module.
